(19) United States
(12) Patent Application Publication
(10) Pub. No.: US 2015/0348056 A1
(43) Pub. Date: Dec. 3, 2015

(54) Technique, method and process for generating one or more Non-sequential Unique Random Alpha Numeric Strings.

(71) Applicant: Raja Sekhar Surapaneni, East Brunswick, NJ (US)

(72) Inventor: Raja Sekhar Surapaneni, East Brunswick, NJ (US)

(21) Appl. No.: 14/813,334

(22) Filed: Jul. 30, 2015

Related U.S. Application Data
(60) Provisional application No. 62/004,894, filed on May 30, 2014.

(51) Int. Cl. G06Q 30/00

(52) U.S. Cl. CPC G06Q 30/018

(57) ABSTRACT

The present disclosure provides for a technique, method and process for generating, within one or more computing devices, one or more Non-sequential Unique Random Alpha Numeric Strings or NURANS unique between themselves and/or unique from a set of given NURANS already existing for use as unique identifiers etc. In accordance with the present disclosure, one or more unique multilingual alpha/numeric/symbol strings may be generated and delivered online/offline or stored in one or more database/memory/storage location where the generated string is unique from all the other strings in a database table column, memory location or neural network. The database may be stored on a computing device or a device connected to a computer or a networked/online/big data/cloud platform and rendering NURANS on demand. The NURANS are generated by using a base seed from timer device or by a random part of a computer-dependent timestamp or alternately entered/obtained random numeric digits.

### BRIEF DISCLOSURE

NURANS are strings of numbers, (lower or upper case) characters of any language or symbols of a symbol set generated to be unique between themselves and/or unique from a set of given NURANS so they can be used as unique identifiers or serial numbers of products or the kind for different purposes. Once generated the NURANS may be used in any form the user pleases to uniquely identify any device/item/thing/service from others of its type. The sub-seconds part of a computer or computing/timing device or from software/firmware routine or external/internal timing device generated timestamp is used as the key in generation of the NURANS in conjunction with a Random Alpha Numeric Character/Symbol returning routine or RANC. The sub-seconds part may be milli, micro, nano or other types of partitions of a second based on the requirement of the generation. Alternately random alpha numeric characters/symbols may be accepted from the user input or a connected timer device. As explained further in this disclosure, the output of NURANS cannot be influenced by manipulating the input in any way.

One or more numbers of the sub-seconds part of the timestamp is extracted and used to determine which character locations are to be looked up in the existing data for randomness. If no existing data is available for uniqueness lookup, the extracted sub-second numbered locations is used as a seed for the RANC to generate a few NURANS which may be used as existing data to further generate NURANS. The generated NURANS may be temporarily or permanently stored (based on requirement) in an array or storage location or a database table column or big data container for easy retrieval and lookup as needed.

This technique and system represents an improvement over previous and currently available systems because it allows for very quick generation of NURANS based on very few lookups on the existing data resulting in the uniqueness of the NURANS being generated even before they are actually generated. In fact looking up on existing NURANS for uniqueness is key of generating future unique NURANS as mentioned in the disclosure. Current technologies generate strings in different ways before even looking up the existing data which is not efficient as explained later in the disclosure. With current technologies, uniqueness of the string is determined/looked up only after the string is completely generated and will result in a lot of wasted iterations in case the generated string is found not to be unique from strings available in the existing data storage location.

### BACKGROUND

The present disclosure relates to generation of NURANS on demand, unique between themselves and between other strings, already generated & stored in a particular location, and more particularly to a machine generated form of string or more of a sequence of alpha numeric characters/symbols/digits. The NURANS once generated can be printed/depicted/integrated in the form of a two dimensional barcode, a three-dimensional bar code, a QR code, RFID tag or Magnetic or the like machine readable tag, incorporated on the product label or product packaging to be used as a serial number or a unique product identifier.

There are currently different kinds of serial number or Unique product identifier printing/incorporating technologies, viz. on a paper label, acrylic/plastic label, metallic tag, permanent ink's/varying color inks/magnetic inks etched on to the product itself etc. The present disclosure doesn't claim to generate/create/implement any kind of secure label or secure reading technologies but just claims to be able to generate NURANS which may be further used in the place of the existing product serial number strings in numeric, symbolic or character/string form.

World population is on a continuous rise and business needs are growing for businesses and Governments alike to be able to generate and track products with serial numbers for human consumption and/or industrial/business consumption. This exponential growth has resulted in the need to be able to track the products with some kind of unique product identifiers or serial numbers from the date of manufacture to the date of their oblivion so to say. Most governments have already mandated that any product/item/service being delivered for governmental consumption or defense mechanisms needs to be tracked with a unique serial number string so they can be identified if and when required. Major retailers like Wal-Mart have mandated that every product sold to/by them is to be identified individually with a unique identification number. Recently FDA, Government of India and EU etc. have mandated that all the Secondary and tertiary packaging of Pharmaceutical drugs have to be tracked individually from manufacture to the point of final dispensing to the end consumer. Other Governmental bodies and big businesses have already mandated Individual product identification from manufacturer to end user for their own inventory purposes or to comply with different laws like pedigree laws. Technologies have been developed for individual product identification using numeric digits and are being used by different software developers.

It's a well-known fact that numbers only cover 10 different combinations per character/symbol digit and alpha numeric characters cover 36 (Upper case and numbers) or 62 (numbers, upper, lower case) combinations per character. Using the ASCII character set one can cover 255 different combinations per character/symbol digit. For example using a 7 numerical digit string we can identify up to 10 million products; using 7 (upper case) alpha numeric characters string we can identify 78 billion products; using 7 (upper, lower case) alpha numeric characters string we can identify 3.5 trillion products and using 255 Ascii character symbol set we can identify 70 quadrillion products. Using this example the reader of this disclosure can appreciate how complicated it gets to be able to generate serial numbers for entire pharmaceutical industry covering 7 billion people (world population) as being Mandated by the FDA in USA for 2020 and EU in Europe. On an other example, USPS has been using 22 digit numeric tracking numbers (in 2014) to track mail i.e. 10 sextillion (1 followed by 21 zeros) while twenty times the same (200 quadrillion) number of packages can be tracked using 13 alphanumeric tracking numbers resulting in a savings of printing and/or looking up 9 characters.

Similarly reducing the size of the serial number of a product can provide a lot of savings when space and readability issues are concerned. For example every bullet manufactured cannot be tracked currently because of the space concerns of using number strings to track them. But if alpha numeric strings are used as serial numbers every bullet manufactured can be tracked. Such tracking would assist the Law enforcement in tracing gun related homicides to the location of purchase and to the picture of the buyer of the bullets very quickly. Furthermore tracking bullets would reduce the usage of expired bullets or ammo.

Furthermore any numbering scheme for serial numbers or unique identifiers should be futuristic and cover any future requirements of such scheme and cannot be content with the current available requirements. Thus introducing ASCII, multilingual character sets and/or symbols as unique identifiers has the benefit of being able to uniquely identify more products than with simple numbers.

As it can be seen, there is a need for a technique and method to be developed catering to provision of services to the business and governmental sectors in generating the serial numbers as required for tracking the products for years to come.

### SUMMARY

In one aspect of the present disclosure a NURANS generating system comprises of a computerized information system, program or service for generating NURANS from the sub-seconds in timestamp of a computing device or a software/firmware routine or from an external/internal timing device or human entry; a networked/cloud or local/online/offline database or memory location, storing the NURANS after verifying they are unique to the storage location along with other relevant details; and/or a computerized information delivery system for delivering/transmitting/displaying/printing the generated one or more NURANS on demand in html/xml/csv/json or any other formats as required by an user; where in the NURANS is used as a serial number or other unique identifier for a product/item or service in a human or machine readable format.

In another aspect of the present disclosure, a NURANS generating system comprises of a micro, mini or handheld or smaller computing device or Artificial Intelligence—AI or Machine learning—ML device/system containing a computerized software/firmware system, program or service for generating NURANS from the sub-seconds in timestamp of the computing device or a software/firmware routine or a form of an external/internal timing device or human entry; a networked/cloud or local/online/offline database or memory location, storing the generated NURANS and delivering/transmitting/displaying/printing the generated one or more NURANS along with other relevant details on demand or as required in machine or human readable format as requested by the user; where in the NURANS is used as a serial number or other unique identifying number for a product/item or service in a human or machine readable format.

In another aspect of the present disclosure, a NURANS generating system comprises an AI server system, program or application based on networked/cloud or local/online/big data/offline server containing a computerized software/firmware/AI/ML system, program or service for generating NURANS from the sub-seconds in timestamp of the computing device or a software/firmware routine or a form of an external/internal timing device or human entry; a networked/cloud or local/online/big data/offline database or memory location, storing the generated NURANS and delivering/transmitting/displaying/printing the generated one or more NURANS along with other relevant details on demand or as required in machine or human readable format as requested by a printing/display device; a micro, mini or handheld or smaller computing device receiving the NURANS from the server and displaying/printing the NURANS onto a label intended for a product or integrating the NURANS data into any packaging/printing system; where in the NURANS is used as a serial number or other unique identifying number for a product/item or service in a human or machine readable format.

In another aspect of the present disclosure, a NURANS generating system comprises of a laptop/palmtop/mini/micro/mobile/handheld or larger computing device/system containing a computerized software/firmware/mobile/AI/ML application system, program or service for generating NURANS from the sub-seconds in timestamp of the computing device or a software/firmware routine or a form of an external/internal timing device or human entry; a networked/cloud or local/online/big data/offline database or memory location, providing required information to the laptop/palmtop/mini/micro/mobile/handheld or larger computing device generating NURANS, to enable verifying the generated NURANS for uniqueness and delivering/transmitting one or more generated NURANS for direct printing/display/storage of one or more at a time with other relevant details on demand or as required in html/xml/csv/json or any other machine or human readable format as requested by the user and or the laptop/palmtop/mini/micro or handheld or larger computing device; where in the NURANS is used as a serial number or other unique identifying number for a product/item or service in a human or machine readable format.

In another aspect of the present disclosure, a NURANS generating system comprises of one or more internet/intranet/mobile based applications, Mobile app or the like, residing on respective micro or handheld or mobile computing device containing a software/firmware/application/AI/ML system or service for generating NURANS from the sub-seconds in timestamp of the computing device or a software/firmware routine or a form of an external/internal timing device or a human entry; a networked/cloud or local/online/big data/offline database or memory/storage location/array, generating NURANS based on information passed from the micro or handheld or mobile computing device, verifying the generated NURANS for uniqueness with a local or external source and storing the generated NURANS on a local/online/offline database or memory location; where in the NURANS is used as a serial number or other unique identifying number for a product/item or service in a human or machine readable format.

In another aspect of the present disclosure, a NURANS generating system comprises of a mobile based application residing on a micro or mini or handheld or mobile phone or tablet accessing/updating/creating NURANS data; a software/firmware/application/AI/ML system, program or service residing on a networked/cloud or local/online/offline server for generating NURANS from the sub-seconds in timestamp of the device or a software/firmware routine or a form of an external/internal timing device or human entry; a networked/cloud or local/online/big data/offline database or memory location/array, storing NURANS, verifying them for uniqueness with a networked/cloud or local/online/big data/offline database or memory location and storing them in a network array/storage location/database in any machine or human readable format as required by the situation; where in the NURANS is used as a serial number or other unique identifying number for a product/item or service in a human or machine readable format.

In another aspect of the present disclosure, a NURANS generating system comprises of a software/firmware/application system, program or service residing on a client computing system generating NURANS from the sub-seconds in timestamp of the device or a software/firmware routine or a form of an external/internal timing device or human entry; a software/firmware/application/AI/ML system, program or service residing on a networked/cloud or local/online/big data/offline server for receiving the generated NURANS, verifying them for uniqueness with a networked/cloud or local/online/offline database or memory location and storing them in a network array/storage location/database in any machine or human readable format as required by the situation; where in the NURANS is used as a serial number or other unique identifying number for a product/item or service in a human or machine readable format.

In another aspect of the present disclosure, a NURANS generating system comprises a server system, program or application based on networked/cloud or local/online/big data/offline server containing a computerized software/firmware system, program or service for generating NURANS from the sub-seconds in timestamp of the computing device or a software/firmware routine or a form of an external/internal timing device or human entry; a networked/cloud or local/online/big data/offline/internal/external database or memory location, verifying them for uniqueness with a networked/cloud or local/online/offline database or memory location and storing them in a network array/storage location/database; a local/online/big data/offline server delivering/transmitting/displaying the generated one or more NURANS along with other relevant details in html/xml/csv/json or any other machine or human readable format on demand or as required; a micro, mini, handheld or similar computing device requesting for creation/delivery of NURANS in customizable formats, sending, receiving and interpreting the data format from/to the delivering server as a SMS message, XML message, email message, SOAP message, Http get/put message, ftp message, webpage or the like of communication in human or machine readable form; where in the NURANS is used as a serial number or other unique identifying number for a product/item or service in a human or machine readable format.

In another aspect of the present disclosure, a NURANS generating system comprises of a software/firmware/routine/function/AI/ML stored on a programmable memory device generating NURANS from the sub-seconds in timestamp of the computing device or a software/firmware routine or a form of an external/internal timing device or delivered human entry; a software/firmware/application/AI/ML system, program or service residing on a computing system communicating with the memory device and providing all the relevant information to the memory device to assist/make the memory device generate and or return NURANS; a networked/cloud or local/online/big data/offline/internal/external system, program or software/firmware, verifying the generated NURANS for uniqueness with a networked/cloud or local/online/big data/offline database or memory location and storing them in a network array/storage location/database in any machine or human readable format on demand or as required; where in the NURANS is used as a serial number or other unique identifying number for a product/item or service in a human or machine readable format.

In another aspect of the present disclosure, a NURANS generating system comprises of a subroutine/function/stored procedure/trigger/AI/ML or like residing in/communicating to a database or data processing/storage/accessing system on a computing device containing a software/firmware/application/AI system or service for generating NURANS from the sub-seconds in timestamp of the computing device or a software/firmware routine or a form of an external/internal timing device or human entry; a networked/cloud or local/online/big data/offline database or memory location/array, generating and/or storing NURANS generated by the subroutine/function/stored procedure/trigger or like, verifying them for uniqueness and delivering/transmitting the generated NURANS for direct printing/display/storage of one or more at a time with other relevant details on demand or as required in any machine or human or system/database readable format as required; where in the NURANS thus generated may be used as a serial number or other unique identifying number for a product/item or service in a human or machine readable format.

In a future aspect of the present disclosure, a NURANS generating system comprising of an operating system included/resident subroutine/function/firmware/program/AI/ML generating NURANS from the sub-seconds in timestamp of the computing device or a software/firmware routine or a form of an external/internal timing device or human entry; a subroutine/function/procedure of the operating system verifying the generated NURANS for uniqueness and storing them in a memory location/array/storage location/database; a software/firmware routine assigning NURANS to different operating system processes as required; where in the NURANS thus generated may be used as a serial number or other unique identifying number for different operating products or service in a human or machine readable format.

In an alternate aspect of the present disclosure a NURANS generating system comprises of a process of generating and using numerical NURANS to return multi lingual alpha numeric NURANS from a list of existing Sequential Multi-Lingual Unique Alpha Numeric Symbol Strings for the convenience of the generator or the user, where in the generated multilingual alpha numeric symbol NURANS are utilized in the different aspects mentioned above between 008 to 0018

These and other features, aspects and advantages of the present disclosure may be better understood with reference to the included following drawings, descriptions and claims.

### BRIEF DESCRIPTION OF THE DRAWINGS

FIG. 1 is a complete view of the process of generating NURANS using RANC and the sub-seconds in a timestamp or random numbers received from other modes of input according to an exemplary embodiment of the present disclosure.

FIG. 2 is a flow chart describing the overall process of generation of Random Alpha Numeric

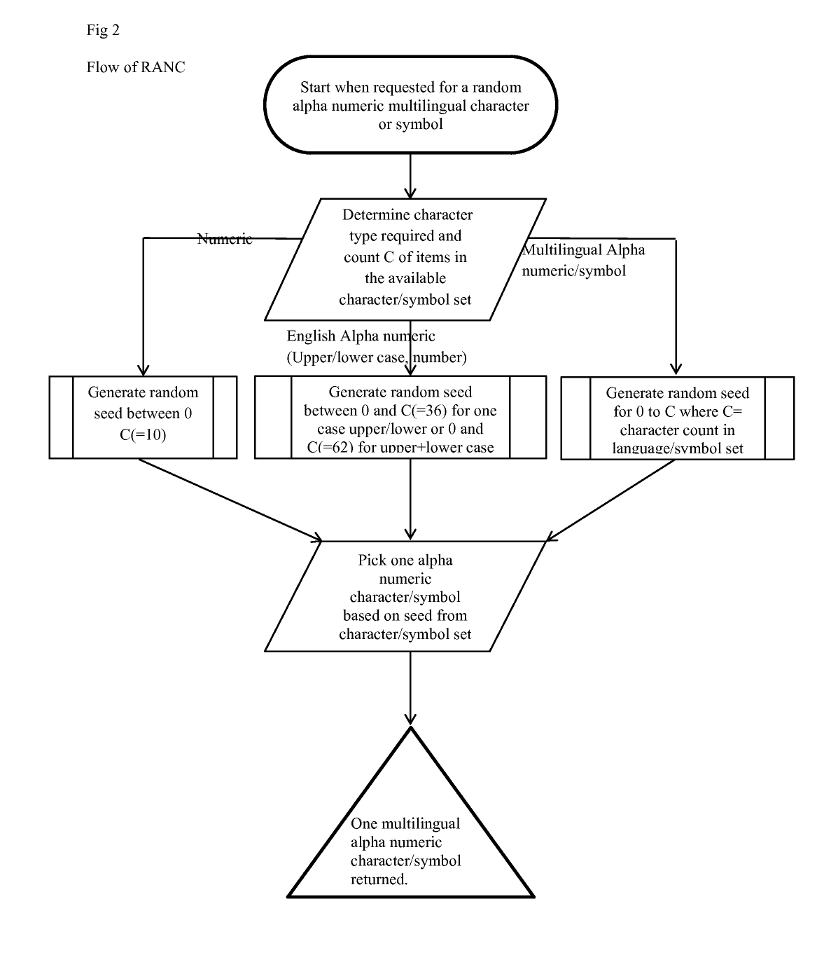

Character/Symbol on request to be utilized in generation of NURANS using and numeric, alpha, symbols, or character sets as required for NURANS generation

FIG. 3 is a tiny partial list of different character/symbol sets available and example 3 and 5 character/item NURANS.

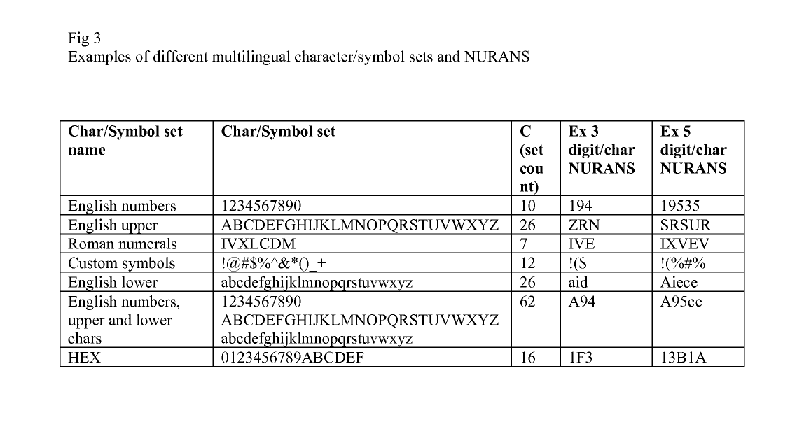

FIG. 4 is a flow chart describing the process of generation of Sequential Multi-Lingual Unique Alpha Numeric Symbol Strings to be used in generating NURANS at a later stage.

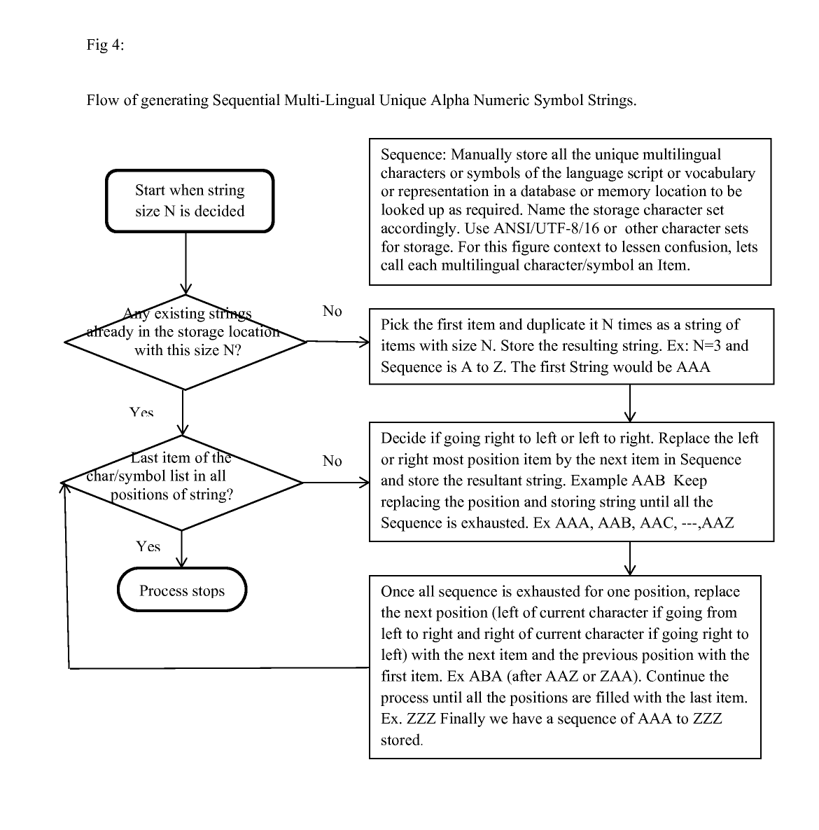

FIG. 5 is a flow chart describing the process of generating NURANS based on numeric NURANS and the sub-seconds in a timestamp or random numbers received from other modes of input according to an exemplary embodiment of the present disclosure.

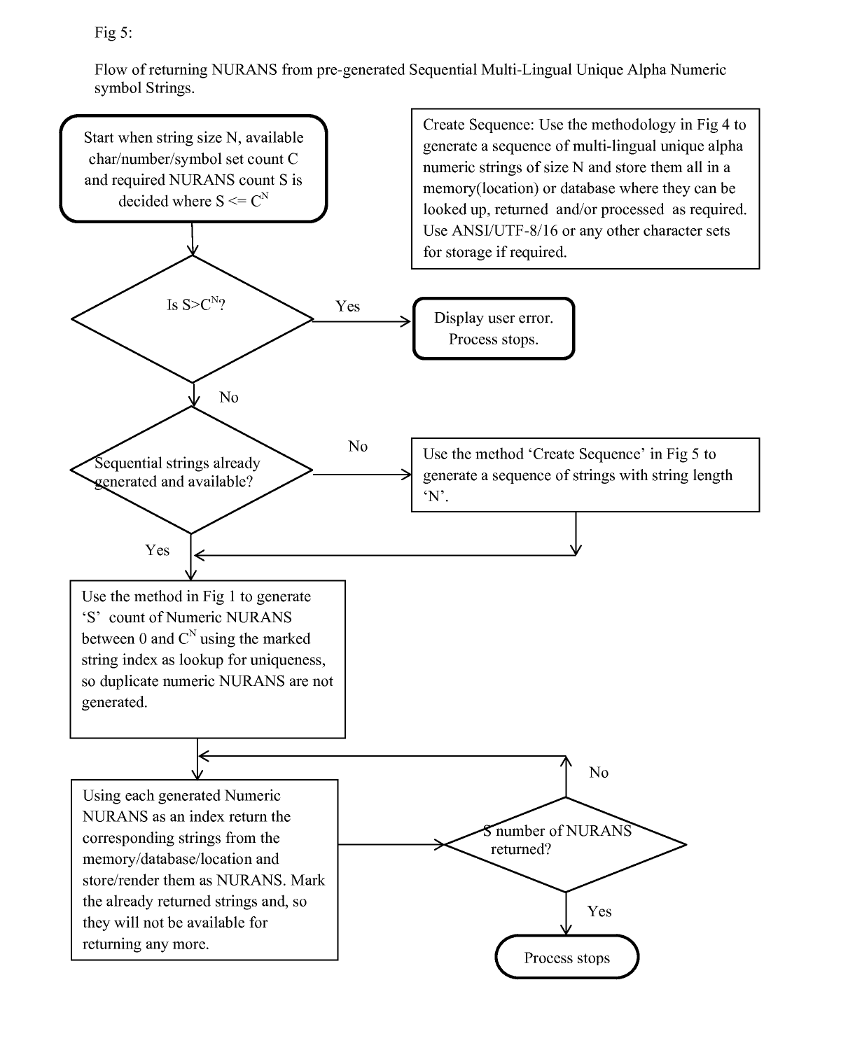

### DETAILED DESCRIPTION

The following detailed description of the invention depicts the best currently contemplated modes of carrying out exemplary embodiments of the invention. The description is not to be taken in a limiting sense, but is being made basically for the purpose of illustrating the general principals of the invention because the scope of any invention is best defined by appended claims.

Broadly, an embodiment of the present invention provides a technique, method and process of generating NURANS on demand, unique between themselves and/or between other similar strings if any, already generated & stored in a particular memory location/array or a database. The NURANS are generated based on the sub-seconds part of a timestamp obtained either from a computing device or a software/firmware routine or a form of an external/internal timing device or by human entry. Once generated the NURANS may be stored either in the generating device or a remote device or a networked/cloud or local/online/big data/offline database or memory location/array along with the already existing strings so that the next newly generated NURANS would be unique in all perspectives. The NURANS so generated may be used as a serial number or unique identification code for products/items or services making them traceable/track-able and/or verifiable from manufacture to consumption by the user.

This disclosure allows for a technique, method or system to generate newer NURANS based on the existing NURANS, making the system efficient enough to generate unique NURANS in a way that the NURANS is tested to be unique even before it is generated because of its employment of the database of previous NURANS in the process of generating new NURANS. This would eliminate a lot of iterations and time required to generate NURANS and then test them for uniqueness there by increasing productivity and resulting in customer satisfaction.

There are currently no advertised systems designed to generate NURANS at a quick pace while maintaining uniqueness between NURANS as they are being generated. Most of the systems in use now are only generating unique numeric strings and cannot handle alpha characters or symbols per se. Some of the current systems can generate alpha numeric strings, but they do generate the whole string using random alpha numeric characters first and then verify its uniqueness by attempting to store it in a database table with unique database constraints or looking it up for uniqueness before storing it. Some other systems currently in use employ different formulas like Fibonacci series etc which do not allow for reuse of the numbers which have been left out while the first run of the system. The system of the present invention provides such a facility to determine the uniqueness of the generated NURANS before its really generated.

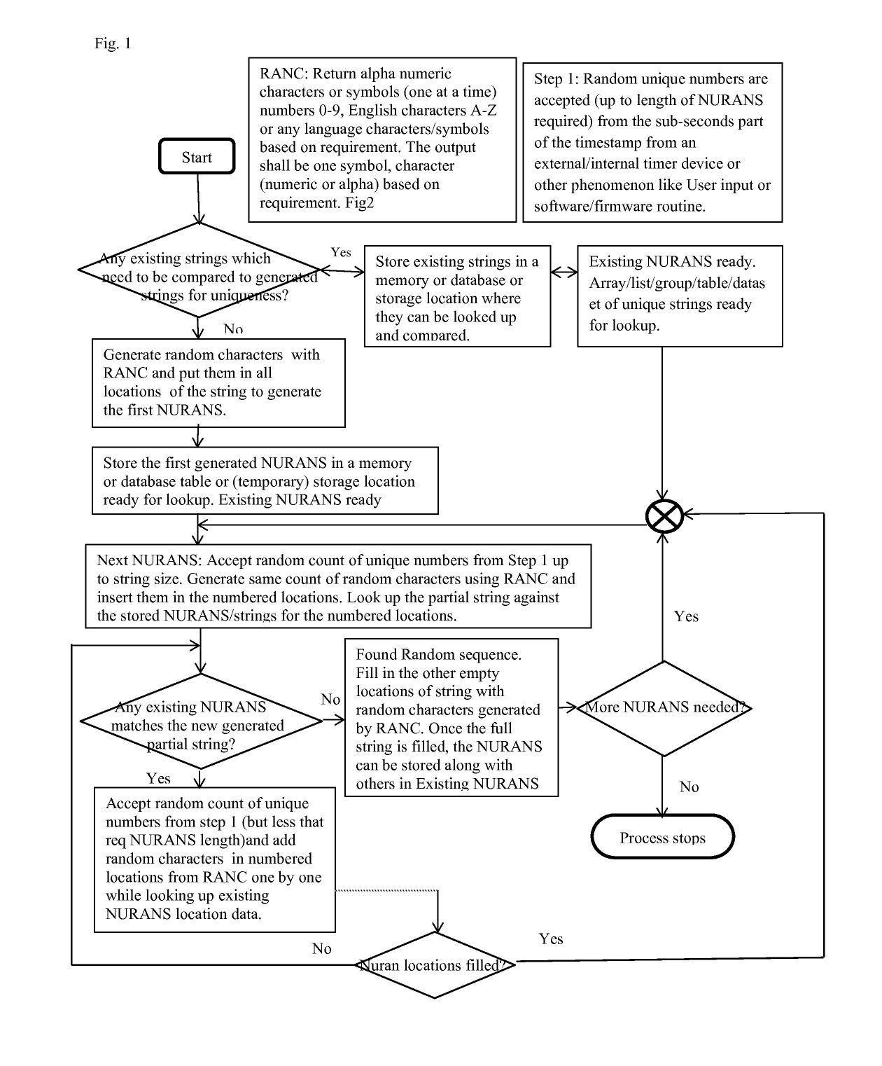

Referring to FIG. 1 the technique, method and system need to be told if there are any prior data strings which the new generated NURANS are to be unique from. If there are any such strings then those strings are stored in an array/memory/storage location or database in a format they can be looked up. If there aren't any prior strings then one NURANS is generated and stored in an array/memory/storage location or database and used for lookup. Now the method is ready for new NURANS generation. Random count of unique numbers are selected either from a sub-seconds part of a timestamp obtained either from a computing device or a software/firmware routine or a form of an external/internal timing device or by human entry. Random alpha numeric characters are inserted into the (being generated) NURANS locations as pointed by the Random unique numbers and the resultant partial NURANS is looked up for uniqueness. If the partial string is unique then the other characters are filled in with random characters and the NURANS is ready and unique. If partial string is not unique then more random numbers are accepted and random characters are filled into the unfilled locations. Alternately if the string is already filled and no unique NURANS is found then the partial NURANS is dumped and the process restarts from taking random numbers This process is repeated with more random numbers and characters until an unique partial NURANS is found.

The routine to generate NURANS or RANC can be either stored on a web/online/cloud/networked/AI/ML server to generate NURANS on demand/offline or stored on a handheld device like a mobile phone or tablet to connect to a Internet/intranet/web/cloud/networked server and do the NURANS generation on a handheld device when required so. The NURANS database may be disposed on one or more computing systems and can be accessed by various means, i.e. through the internet, through a local, metropolitan or wide area network or SMS or MMS or Email or the like. The data in the database may be stored on one or more server computers or on a cloud or parallel computing based storage. Access to the NURANS database lookups may be made available from a personal computer or smartphone via a client/server software, web markup language/service, web page or application.

In some embodiments of the current disclosure the NURAN data and its related data may be processed and/or mined for information and reports to achieve functionality in lot of ways including but not limited to the ones mentioned in different aspects of the present invention.

In some embodiments of the current disclosure, the server(s) and/or database/memory hosting the NURANS and NURANS generating technique, method or system may be employed by the relevant authorities and NURANS issued to businesses, organizations and other government agencies on demand/request.

In some embodiments of the current disclosure, the server(s) and/or database/memory hosting the NURANS and NURANS generating technique, method or system may be employed by one party and NURANS issued to businesses, organizations, authorities and other users on demand/request on a pay per use basis.

In some embodiments of the current disclosure a process of generating NURANS from a pre generated list of Sequential Multi-Lingual Unique Alpha Numeric Symbol Strings may be employed in situations where generation of multilingual alpha numeric symbols NURANS is not advisable or possible.

It should be understood, of course, that the foregoing relates to exemplary embodiments of the invention and that modifications may be made without departing from the spirit and scope of the invention as set forth in the attached claims.

What is claimed is:

1. A technique, process, method and system comprising:
of a computerized information system or service for generating NURANS from the sub-seconds in timestamp of a computing device or a software/firmware routine or from an external/internal timing device or human entry
a networked/cloud or local/online/big data/offline database or memory location, storing the NURANS after verifying they are unique to the storage location and/or target data along with other relevant details

2. An alternate technique, process method and system comprising:
of creating Sequential Multi-Lingual Unique Alpha Numeric Symbol Strings with multi-lingual alpha numeric character or symbol set and storing them in a lookup list or a networked/cloud or local/online/big data/offline database or memory location
of generating numeric NURANS mentioned in claim 001 as random numbers and using the random numbers as index to pick Sequential Multi-Lingual Unique Alpha Numeric Symbol Strings one at a time and deliver them as NURANS
of using the generated and stored numeric NURANS as a lookup base for generating further unique numeric NURANS as random numbers to pick Sequential Multi-Lingual Unique Alpha Numeric Symbol Strings one at a time as NURANS from the pre created strings as and when required
alternately of generating more random unique numeric strings to pick previously not picked Sequential Multi-Lingual Unique Alpha Numeric Symbol Strings one at a time as NURANS from the pre created strings as and when required
a networked/cloud or local/online/big data/offline database or memory location, storing the NURANS thus picked from the Sequential Multi-Lingual Unique Alpha Numeric Symbol Strings generated after verifying they are unique to the storage location and/or target data along with other relevant details
comprising of a computerized information delivery system for delivering/transmitting/displaying/printing one or more NURANS on demand in different character sets, character counts, sizes and types on demand in json/html/xml/csv or any other encrypted/unencrypted formats as requested by the user or client/mobile/server system or internal/external service, where in the NURANS may be used as a serial number, activation/security/encryption key/code or other unique identifying number for a product/item or service in a human or machine readable format

3. The NURANS generating system of claim 001 comprising of a computerized information delivery system for delivering/transmitting/displaying/printing the generated one or more NURANS on demand in json/html/xml/csv or any other encrypted/unencrypted formats as requested by the user or client/mobile/server system or internal/external service, where in the NURANS may be used as a serial number or other unique identifying number for a product/item or service in a human or machine readable format

4. The NURANS generating system of claim 003, generating/storing/hosting the NURANS and delivering the generated NURANS customized in different character sets, character counts, sizes and like types on demand to a hand held or mini or micro or small or personal computing/printing/display device to be used as unique product identifiers or serial numbers of products, items or services comprising NURANS:
printed/depicted/integrated in the form of a two dimensional barcode, a three-dimensional bar code, a QR code, RFID tag or Magnetic or the like machine and/or human readable tag
incorporated on the product label or product packaging to be used as a serial number or a unique product identifier

5. The NURANS generating system of claim 003, generating/storing/hosting the NURANS and providing them as and when required/requested for as per the requirement of the users, customized in different character sets, character counts, sizes and types where in the provided NURANS may be used as authentication tokens, security keys, activation keys, encryption keys, serial numbers, security codes of products, items or services
delivered/rendered to a system/server/service/cloud/database/VPN/Client which utilizes the NURANS as a security key or unique code to identify a process, device or a service
delivered/rendered to a system/server/service/cloud/database/VPN/mobile device/program which utilizes the NURANS as a security key or unique code to encrypt/decrypt communications from/to it to its trusted devices/network/clients/partners or such
delivered/rendered to two or more computing devices/services/systems/programs which use the NURANS as keys to set up secure/encrypted communications between themselves and their partners
delivered/rendered to a client and server as personal keys in the process of setting up symmetric encryption and integrity checks where NURANS is employed as a symmetric key in the place of symmetric keys generated by an algorithm or code

6. The method embodied in claim 004, where in items are products or services which are currently in the supply chain and/or may be sold in the future in retail/wholesale/online/barter for consumption by an end user/consumer can be identified based on the NURANS as their serial number or unique product identifier.

7. The NURANS generating system of claim 003 generating NURANS on a micro/mini/remote/handheld system using the resources via network/wireless/mobile connectivity from the database/storage system/infrastructure comprising:
of a micro, mini or handheld or smaller computing device containing a computerized software/firmware system, program or service for generating NURANS from the sub-seconds in timestamp of the computing device or a software/firmware routine or a form of an external/internal timing device or human entry
a networked/cloud or local/online/big data/offline database or memory location, storing the generated NURANS and delivering/transmitting/displaying/printing the generated one or more NURANS along with other relevant details on demand or as required in machine or human readable format as requested by the user
where in the NURANS is used as a serial number or other unique identifying number for a product/item or service in a human or machine readable format

8. The NURANS generating system of claim 003 where generated NURANS are employed on a handheld system via network/wireless/mobile connectivity from the database/storage system/infrastructure comprising:
a server system, program or application based on networked/cloud or local/online/big data/offline server containing a computerized software/firmware system, program or service for generating NURANS from the sub-seconds in timestamp of the computing device or a software/firmware routine or a form of an external/internal timing device or human entry
a networked/cloud or local/online/offline database or memory location, storing the generated NURANS and delivering/transmitting/displaying/printing the generated one or more NURANS along with other relevant details on demand or as required in machine or human readable format as requested by a printing/display device
a micro, mini or handheld or smaller computing device receiving the NURANS from the server and displaying/printing the NURANS onto a label intended for a product or integrating the NURANS data into any packaging system of a product
where in the NURANS is used as a serial number or other unique identifying number for a product/item or service in a human or machine readable format.

9. The NURANS generating system of claim 003 generating NURANS on a laptop/palmtop/mini/micro/mobile or handheld device via network/wireless/mobile connectivity from the database/storage system/infrastructure comprising:
of a laptop/palmtop/mini/micro/mobile/handheld or larger computing device containing a computerized software/firmware/mobile application system, program or service for generating NURANS from the sub-seconds in timestamp of the computing device or a software/firmware routine or a form of an external/internal timing device or human entry
a networked/cloud or local/online/big data/offline database or memory location, providing required information to the laptop/palmtop/mini/micro/mobile/handheld or larger computing device generating NURANS, to enable verifying the generated NURANS for uniqueness and delivering/transmitting one or more generated NURANS for direct printing/display/storage of one or more at a time with other relevant details on demand or as required in html/xml/csv or any other machine or human readable format as requested by the user and or the laptop/palmtop/mini/micro or handheld or larger computing device
where in the NURANS is used as a serial number or other unique identifying number for a product/item or service in a human or machine readable format

10. The NURANS generating system of claim 003 generating NURANS on a networked/cloud or local/online/big data/offline database or memory location based on interaction with internet/intranet/mobile based applications comprising
of one or more internet/intranet/mobile based applications (Mobile app or the like) residing on respective micro or handheld or mobile computing device containing a software/firmware/application/AI system or service for interacting with the server to relay any and all information required for the NURANS generation
a networked/cloud or local/online/big data/offline database or memory location generating NURANS from the sub-seconds in timestamp of the computing device or a software/firmware routine or a form of an external/internal timing device or a human entry, generation parameters based on information passed from the micro or handheld or mobile computing device, verifying the generated NURANS for uniqueness with a local or external source and storing the generated NURANS on a local/online/offline database or memory location
where in the NURANS is used as a serial number or other unique identifying number for a product/item or service in a human or machine readable format

11. The NURANS generating system of claim 003 generating NURANS on a networked/cloud or local/online/big data/offline database or memory location based on interaction with internet/intranet/mobile based applications comprising:
of a mobile based application residing on a micro or mini or handheld or mobile phone or tablet accessing/updating/creating NURANS data
a software/firmware/application system, program or service residing on a networked/cloud or local/online/offline server for generating NURANS from the sub-seconds in timestamp of the device or a software/firmware routine or a form of an external/internal timing device or human entry
a networked/cloud or local/online/big data/offline database or memory location/array, storing NURANS, verifying them for uniqueness with a networked/cloud or local/online/big data/offline database or memory location and storing them in a network array/storage location/database in any machine or human readable format as required by the situation
where in the NURANS is used as a serial number or other unique identifying number for a product/item or service in a human or machine readable format

12. The NURANS generating system of claim 003 generating NURANS on a networked/cloud or local/online/offline database or memory location based on interaction with a client computing system comprising:
of a software/firmware/application/AI system, program or service residing on a client computing system generating NURANS from the sub-seconds in timestamp of the device or a software/firmware routine or a form of an external/internal timing device or human entry
a software/firmware/application/AI system, program or service residing on a networked/cloud or local/online/big data/offline server for receiving the generated NURANS, verifying them for uniqueness with a networked/cloud or local/online/big data/offline database or memory location and storing them in a network array/storage location/database in any machine or human readable format as required by the situation
where in the NURANS is used as a serial number or other unique identifying number for a product/item or service in a human or machine readable format

13. The NURANS generating system of claim 003 generating NURANS on a networked/cloud or local/online/big data/offline web server or other kinds of servers for use on one or more clients comprising:
a server system, program or application based on networked/cloud or local/online/big data/offline server containing a computerized software/firmware system, program or service for generating NURANS from the sub-seconds in timestamp of the computing device or a software/firmware routine or a form of an external/internal timing device or human entry
a networked/cloud or local/online/big data/offline/internal/external database or memory location, verifying the generated NURANS for uniqueness with a networked/cloud or local/online/big data/offline database or memory location and storing them in a network array/storage location/database
a local/online/big data/offline server delivering/transmitting/displaying the generated one or more NURANS along with other relevant details in json/html/xml/csv or any other machine or human readable format on demand or as required
a micro, mini, handheld or similar computing device requesting for creation/delivery of NURANS in customizable formats, sending, receiving and interpreting the data format from/to the delivering server as a SMS message, XML message, email message, SOAP message, Http get/put message, ftp message, webpage or the like of communication in human or machine readable form
where in the NURANS is used as a serial number or other unique identifying number for a product/item or service in a human or machine readable format

14. The NURANS generating system of claim 003 generating NURANS using a software/firmware/routine/function stored on a programmable/storage memory device comprising:
of a software/firmware/routine/function stored on a programmable/storage memory device generating NURANS from the sub-seconds in timestamp of the computing device or a software/firmware routine or a form of an external/internal timing device or delivered human entry
a software/firmware/routine/application/AI system, program or service residing on a computing system communicating with the memory device and providing all the relevant information to the memory device to assist/make the memory device generate NURANS
a networked/cloud or local/online/big data/offline/internal/external system, program or software/firmware, verifying the generated NURANS for uniqueness with a networked/cloud or local/online/big data/offline database or memory location and storing them in a network array/storage location/database in any machine or human readable format on demand or as required
where in the NURANS is used as a serial number or other unique identifying number for a product/item or service in a human or machine readable format

15. The NURANS generating system of claim 003 generating NURANS using a software/subroutine/stored procedure/trigger/function stored in a database or data processing device/application comprising:
a subroutine/function/stored procedure/trigger or like, residing in/communicating to a database or data processing/storage/accessing system on a computing device containing a software/firmware/application system or service for generating NURANS from the sub-seconds in timestamp of the computing device or a software/firmware routine or a form of an external/internal timing device or human entry
a networked/cloud or local/online/big data/offline database or memory location/array, generating and/or storing NURANS generated by the subroutine/function/stored procedure/trigger or like, verifying them for uniqueness and delivering/transmitting the generated NURANS for direct printing/display/storage of one or more at a time with other relevant details on demand or as required in any machine or human or system/database readable format as required
where in the NURANS thus generated may be used as a serial number or other unique identifying number for a product/item or service in a human or machine readable format

16. The NURANS generating system of claim 003 generating NURANS using an operating system included/resident subroutine/function/firmware/program comprising:
an operating system included/resident subroutine/function/firmware/program generating NURANS from the sub-seconds in timestamp of the computing device or a software/firmware routine or a form of an external/internal timing device or human entry
a subroutine/function/procedure of the operating system verifying the generated NURANS for uniqueness and storing them in a memory location/array/storage location/database
a software/firmware routine assigning NURANS to different operating system processes as required
where in the NURANS thus generated may be used as a serial number or other unique identifying number for different operating products or services or internal calls in a human or machine readable format.
Although particular embodiments of the invention have been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.
